(19) United States
(12) Patent Application Publication
(10) Pub. No.: US 2026/0061384 A1
(43) Pub. Date: Mar. 5, 2026

(54) MEMBRANE-BASED AUTOTHERMAL AMMONIA REACTOR

(71) Applicant: Saudi Arabian Oil Company, Dhahran (SA)

(72) Inventors: Osamah Siddiqui, Dhahran (SA); Bandar Solami, Dammam (SA)

(21) Appl. No.: 18/824,384

(22) Filed: Sep. 4, 2024

(51) Int. Cl. B01J 8/06; B01D 53/22; B01D 53/26; B01D 69/04; C01B 3/04

(52) U.S. Cl. CPC B01J 8/065; B01D 53/229; B01D 53/261; B01D 69/04; B01J 8/067; C01B 3/047; B01D 2256/16; B01D 2257/102; B01D 2257/80; B01J 2208/065

(57) ABSTRACT

An autothermal ammonia reactor includes a chamber, a hydrogen-separation membrane within the chamber, and an ammonia decomposition catalyst. The chamber receives ammonia and air. The chamber including a combustion zone, a catalytic zone, and a hydrogen zone. The catalytic zone is in thermal communication with the combustion zone. The chamber directs the air and a portion of the ammonia from the fluid inlet to the combustion zone to allow the air and ammonia to exothermically react to generate thermal energy. The chamber directs another portion of the ammonia into the catalytic zone to decompose into hydrogen and nitrogen as the ammonia is exposed to the thermal energy from the combustion zone and contacts the catalyst. The chamber directs the hydrogen from the catalytic zone, through a surface of the hydrogen-separation membrane, to the hydrogen zone to allow the hydrogen to exit the chamber through the fluid outlet.

### TECHNICAL FIELD

This disclosure relates to autothermal ammonia cracking.

### BACKGROUND

Ammonia cracking is the process of producing hydrogen and nitrogen from ammonia. The process involves heating the ammonia and exposing the ammonia to a cracking catalyst until hydrogen and nitrogen are produced from the decomposition of ammonia. The hydrogen is then separated from the nitrogen. This method can be a cost-effective way of producing hydrogen. Methods and equipment for improving the process of ammonia cracking are sought.

### SUMMARY

Implementations of the present disclosure include an autothermal ammonia reactor that includes a chamber, a hydrogen-separation membrane, and an ammonia decomposition catalyst. The chamber has a fluid inlet and a fluid outlet and is arranged to receive, through the fluid inlet, ammonia and air. The chamber includes a combustion zone fluidly coupled with the inlet. The hydrogen-separation membrane is disposed within the chamber. The chamber includes a catalytic zone and a hydrogen zone at the hydrogen-separation membrane and downstream of the catalytic zone. The hydrogen-separation membrane separates the catalytic zone from the hydrogen zone such that the catalytic zone is either surrounded by or surrounding the hydrogen zone and the hydrogen-separation membrane. The catalytic zone is in thermal communication with the combustion zone and the hydrogen zone is fluidly coupled with the fluid outlet. The ammonia decomposition catalyst is disposed within the catalytic zone. The chamber directs the air and a portion of the ammonia from the fluid inlet to the combustion zone to allow the air and the portion of the ammonia to exothermically react to generate thermal energy. The chamber is arranged to direct another portion of the ammonia into the catalytic zone to decompose into hydrogen and nitrogen as the ammonia is exposed to the thermal energy from the combustion zone and contacts the ammonia decomposition catalyst, and the chamber is arranged to direct the hydrogen from the catalytic zone, through a surface of the hydrogen-separation membrane, to the hydrogen zone to allow the hydrogen to exit the chamber through the fluid outlet.

In some implementations, the air and the portion of the ammonia exothermically react to produce nitrogen and water, and the chamber is arranged to direct the produced nitrogen and water out of the chamber. In some implementations, the autothermal ammonia reactor further includes a drying zone disposed between the combustion zone and the catalytic zone. The drying zone includes a drying agent configured to absorb at least some of the water produced in the combustion zone. In some implementations, the drying agent is regenerated in-situ through a passage of a drying gas.

In some implementations, the hydrogen-separation membrane includes a retentate side facing the catalytic zone and a permeate side facing the hydrogen zone. The hydrogen-separation membrane is arranged to prevent the nitrogen from flowing from the catalytic zone to the hydrogen zone such that nitrogen is kept in the catalytic zone in contact with the retentate side. The catalytic zone fluidly coupled to a second fluid outlet through which the nitrogen exits the chamber.

Implementations of the present disclosure include an ammonia reactor that includes a chamber that includes a fluid inlet and a fluid outlet. The chamber receives, through the fluid inlet, ammonia and a reaction fluid. The chamber includes a combustion zone fluidly coupled with the inlet, a decomposition zone in thermal communication with the combustion zone, and a hydrogen zone downstream of the decomposition zone. The hydrogen zone is fluidly coupled with the fluid outlet. The hydrogen-separation membrane resides within the chamber and separates the decomposition zone from the hydrogen zone. The chamber is arranged to direct the reaction fluid and ammonia from the fluid inlet to the combustion zone to allow the reaction fluid and ammonia to exothermically react to generate thermal energy. The chamber is arranged to direct ammonia to the decomposition zone to decompose into hydrogen and nitrogen under the thermal energy from the combustion zone. The chamber is arranged to direct the hydrogen from the decomposition zone, through a surface of the hydrogen-separation membrane, to the hydrogen zone to allow the hydrogen to exit the chamber through the fluid outlet.

In some implementations, the hydrogen zone is at the hydrogen-separation membrane. The hydrogen-separation membrane includes a cylindrical shape or a ring-like shape such that the decomposition zone is either surrounded by or surrounding the hydrogen-separation membrane. The decomposition zone receives, from the combustion zone, unreacted ammonia.

In some implementations, the hydrogen-separation membrane includes a cylindrical shape at a core of the chamber. The hydrogen-separation membrane includes an external and retentate surface that defines, with an internal wall of the chamber, an annulus, the decomposition zone residing within the annulus, and the hydrogen flows inwardly from the annulus to the hydrogen zone within the hydrogen-separation membrane.

In some implementations, the hydrogen zone is at the core of the chamber and spans a length of the chamber. The combustion zone spans the length of the chamber, and the chamber includes a concentric volume fluidly decoupled from and surrounding the combustion zone. The combustion zone resides at the concentric volume.

In some implementations, the hydrogen-separation membrane includes a ring-like shape. The hydrogen-separation membrane includes an internal and retentate surface facing an inner volume at the core of the chamber. The decomposition zone residing within the inner volume at the core of the chamber, and the hydrogen flows outwardly from the inner volume to the hydrogen zone within the hydrogen-separation membrane.

In some implementations, the hydrogen zone spans a length of the chamber such that the hydrogen zone surrounds the combustion zone.

In some implementations, the chamber further includes a second inlet fluidly coupled with the hydrogen zone and receives a sweep gas to sweep the hydrogen out of the chamber.

In some implementations, the chamber further includes a second decomposition zone disposed between the combustion zone and the decomposition zone and including a high-temperature ammonia decomposition catalyst bed. The second decomposition zone is exposed to a temperature from the combustion zone that is higher than a temperature to which the decomposition zone is exposed.

In some implementations, the reaction fluid includes oxygen that exothermically reacts with the ammonia to produce nitrogen and water, and the chamber further includes a drying zone disposed between the combustion zone and the decomposition zone and including a drying agent configured to absorb at least some of the water produced in the combustion zone.

In some implementations, the hydrogen-separation membrane includes a retentate side facing the decomposition zone and a permeate side facing the hydrogen zone. The hydrogen-separation membrane is arranged to prevent the nitrogen from flowing from the decomposition zone to the hydrogen zone such that nitrogen is kept in the decomposition zone in contact with the retentate side. The decomposition zone is fluidly coupled to a second fluid outlet through which the nitrogen exits the chamber.

In some implementations, the ammonia reactor further includes an ammonia decomposition catalyst disposed within the decomposition zone. The decomposition zone includes a catalytic zone. The chamber is arranged to direct unreacted ammonia to the catalytic zone to decompose into hydrogen and nitrogen under the thermal energy from the combustion zone and upon contact with the ammonia decomposition catalyst.

In some implementations, the reaction fluid includes air or oxygen that exothermically reacts with the ammonia to produce nitrogen and water, and the ammonia decomposition catalyst membrane is water-resistant.

Implementations of the present disclosure include a method that includes directing ammonia and a reaction fluid into a combustion zone of a chamber of an ammonia reactor, allowing the ammonia and reaction fluid to exothermically react to generate thermal energy in the combustion zone. The method also includes directing ammonia into a decomposition zone of the chamber. The decomposition zone is in thermal communication with the combustion zone so that the ammonia in the decomposition zone decomposes, under the thermal energy from the combustion zone, into hydrogen and nitrogen. The method also includes, subsequently or simultaneously, directing the hydrogen from the decomposition zone, through a surface of a hydrogen-separation membrane disposed within the chamber, to a hydrogen zone to allow the hydrogen to exit the chamber through the fluid outlet.

In some implementations, the reaction fluid includes at least one of air or hydrogen, and directing the ammonia and the reaction fluid includes directing dry ammonia from a distillation column into the chamber, and directing at least one of (i) air from an air source into the chamber, or (ii) hydrogen from a gas separator into the chamber.

In some implementations, the method further includes directing the hydrogen out of the chamber into a gas separator that separates a sweep gas from the hydrogen.

Particular implementations of the subject matter described in this specification can be implemented so as to realize one or more of the following advantages. For example, autothermal ammonia reactor and method of the present disclosure allows in-situ heat generation, ammonia decomposition, and hydrogen separation to happen in a single reactor, which can increase the rate of hydrogen production, as well as save time and resources. Moreover, the autothermal ammonia reactor of the present disclosure generates heat without burning gas such as natural gas, which can reduce the environmental impact of ammonia cracking. Further, the membrane-based autothermal ammonia reactor of the present disclosure allows the minimization of heat losses as compared to conventional gas-fired heated reactors as the heat generated by the exothermic combustion reaction is contained within the reactor.

### BRIEF DESCRIPTION OF THE DRAWINGS

FIG. 1 shows a schematic view of an ammonia cracking system according to implementations of the present disclosure.

FIG. 2 shows a front, schematic view of an ammonia reactor according to a first implementation of the present disclosure.

FIG. 3 shows a front, schematic view of an ammonia reactor according to a second implementation of the present disclosure.

FIG. 4 shows a front, schematic view of an ammonia reactor according to a third implementation of the present disclosure.

FIG. 5 shows a front, schematic view of an ammonia reactor according to a fourth implementation of the present disclosure.

FIG. 6 shows a front, schematic view of an ammonia reactor according to a fifth implementation of the present disclosure.

FIG. 7 shows a front, schematic view of an ammonia reactor according to a sixth implementation of the present disclosure.

FIG. 8 shows a flow chart of an example method of ammonia cracking.

### DETAILED DESCRIPTION OF THE DISCLOSURE

An ammonia cracker or reactor is a device used to break down ammonia into its components, hydrogen and nitrogen, through a process of ammonia decomposition or cracking. This is typically done by heating the ammonia to high temperatures, often in the presence of a catalyst, which facilitates the reaction. The result is a mixture of hydrogen and nitrogen gases. The hydrogen produced can be used as a fuel or in various industrial processes.

Ammonia cracking conventionally requires multiple reactors or chambers and can be environmentally detrimental. For example, conventional endothermic reactor systems can include multiple burners, reactors, and product separators. For instance, a gas-fired burner has a separate subsystem that provides thermal energy to an ammonia reactor. In conventional gas-fired reactors, natural gas can be used as the fuel to provide the required thermal energy needed by endothermic reactions. However, this results in significant amounts of CO2 emissions. For instance, considering methane as the fuel for providing thermal energy for the ammonia decomposition reaction, 1 mol of ammonia decomposition would result in 0.057 moles of CO2 emissions assuming complete combustion of methane and considering a lower heating value of methane of 802.3 kJ/mol.

Additionally, conventional systems flow the produced nitrogen and hydrogen to a chamber different than the ammonia reactor for pressure swing adsorption to separate the gases. The autothermal ammonia reactor and method of the present disclosure allows for the steps of combustion and hydrogen-nitrogen separation to be performed in a single unit or chamber, which can intensify and enhances the overall process and production.

In-situ heat generation can be attained via an ammonia reaction with air (e.g., ammonia combustion). This avoids the requirement of any external heating source. For example, the ammonia reactor of the present disclosure utilizes a part of the total ammonia feed in an autothermal configuration to provide the required input energy needed for ammonia decomposition. In addition to this, the hydrogen produced in the system as a product of ammonia cracking is also separated in-situ using a hydrogen permeable membrane. Hence, the designed systems allow the generation of heat, ammonia decomposition, and hydrogen separation in-situ within the reactor. Moreover, because ammonia decomposition/cracking is an endothermic process (e.g., requires an energy input for dissociating the ammonia molecule into constituent nitrogen and hydrogen gases) and the chamber produces heat through combustion of a chemical reaction (e.g., an exothermic chemical reaction), the reactor of the present disclosure produces both endothermic and exothermic reactions in-situ to generate hydrogen.

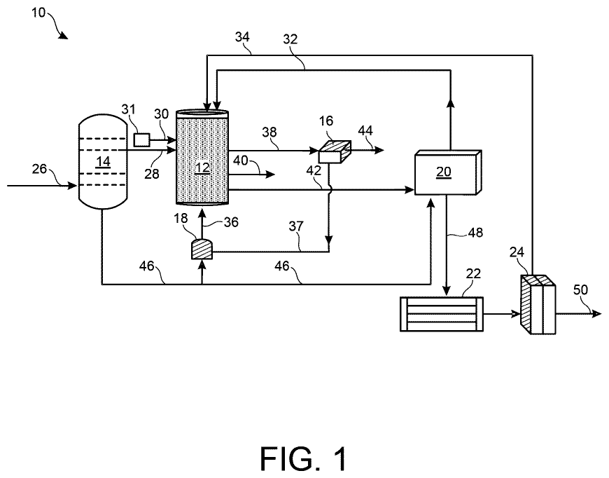

FIG. 1 shows an ammonia decomposition system 10 (e.g., a system block diagram) that includes an ammonia reactor 12 (a membrane-based autothermal ammonia reactor or reactor), a distillation column 14, a sweep gas separator 16, a sweep gas unit 18 (e.g., a boiler), an ammonia polisher 20, a cooling system 22, and a gas separation unit 24 (e.g., a pressure swing adsorption (PSA)-based gas separation unit). First, a first fixture 26 of ammonia with water (e.g., small amounts of water with respect to the amount of ammonia) can enter the distillation column 14 where water is separated to generate a stream of dry ammonia. In some aspects, to transport ammonia, small amounts of water are added to the ammonia to reduce the corrosivity of ammonia and prevent damage to containers or pipes carrying the ammonia. Thus, the first step in the process can include the separation of water to produce dry ammonia that is then fed to the autothermal reactor 12.

Then, a first stream of ammonia 28 (e.g., dry ammonia), air 30, a second stream of ammonia 32 (e.g., polished ammonia), a nitrogen-hydrogen mixture 34 (e.g., nitrogen gas and residual hydrogen gas), and a sweep gas 36 (e.g., water steam) enter the ammonia reactor 12. The first stream of ammonia 28 enters the ammonia reactor 12 from the distillation column 14. The air 30 enters the ammonia reactor from an air source 31 such as an air pump. In some aspects, the first stream of ammonia 28 and air 30 enter the ammonia reactor 12 as a mixture through a single pipe. The second stream of ammonia 32 enters the ammonia reactor from the ammonia polisher 20. The nitrogen-hydrogen mixture 34 enters the ammonia reactor 12 from the gas separation unit 24. In some aspects, the nitrogen and hydrogen can enter the ammonia reactor 12 separately (e.g., through different pipes) instead of mixed. The sweep gas 36 enters the ammonia reactor 12 from the sweep gas mixing unit 18.

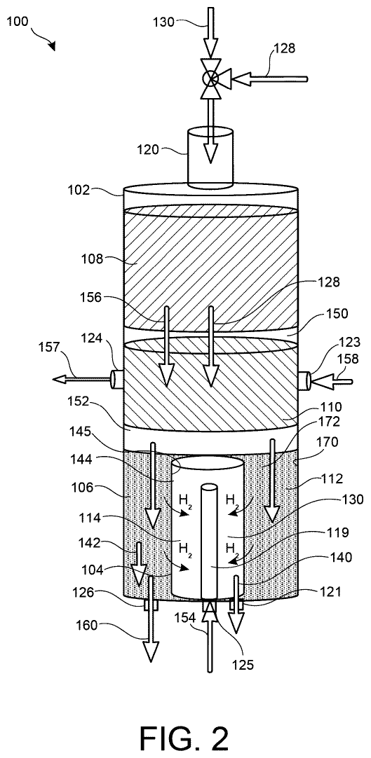

As further described below with respect to FIGS. 2-7, the first stream of ammonia 28 enters the ammonia reactor 12 and all or a portion of the first stream of ammonia 28 reacts with the air 30 and/or hydrogen from the gas separation unit 24. The combustion of the first steam of ammonia 28 with air 30 and/or oxygen generates the heat needed to decompose the ammonia in the ammonia reactor 12. The ammonia that decomposes in the ammonia reactor 12 can be the rest of the first stream of ammonia 28, the second stream of ammonia 32, a portion of the second stream of ammonia 32, or a mixture of these. Alternatively, a portion of the second stream of ammonia 32 can be used for the combustion, and all of the first stream of ammonia 28 can be used for the decomposition process/reaction.

The nitrogen from the gas separation unit 24 can be used to absorb (or to generate a drying agent that absorbs) the water molecules produced during the combustion reaction of the ammonia 28 and air 30. The sweep gas 36 can be used to sweep the permeated hydrogen to the reactor exit.

As further described below with respect to FIGS. 2-7, a hydrogen-sweep gas mixture 38 (e.g., permeated hydrogen with sweep gas), a water-nitrogen mixture 40, and an ammonia-nitrogen-hydrogen mixture 42 (e.g., residual ammonia with unpermeated hydrogen and nitrogen) exit the ammonia reactor 12.

The hydrogen-sweep gas mixture 38 flows to the sweep gas separator 16 where the hydrogen is separated from the sweep gas 36. The sweep gas 36 can then flow back to the ammonia reactor 12 through the sweep gas mixer 18. The separated hydrogen 44 is the permeated hydrogen and the product that the ammonia decomposition system 10 is intended to produce. The separated hydrogen 44 can be flowed, for example, to a storage container. In some aspects, the ammonia decomposition and hydrogen separation via the membrane occur simultaneously.

In some aspects, when steam is utilized as the sweep gas 36, the sweep gas separator 16 includes a steam condenser to condense the steam into water 37. The water 37 from the sweep gas separator 16 is then boiled in the sweep gas unit 18 to turn the water 37 into steam to be used as sweep gas 36. Moreover, the water 46 extracted from the ammonia in the distillation column 14 can flow to the sweep gas unit 18 to be turned into steam to be used as sweep gas 36 in the ammonia reactor 12. In some aspects, all or part of the water 46 can be flowed to the ammonia polisher 20.

The water-nitrogen mixture 40 can be released to the environment or flowed to a container or to the gas separator 24. The ammonia-nitrogen-hydrogen mixture 42 flows to the ammonia polisher 20 polisher where the ammonia is separated and sent back to the ammonia reactor 12. The remaining gaseous mixture 48 of nitrogen and hydrogen is sent to the cooling system 22. The cooling system 22 lowers the temperature of the mixture 48 before the mixture 48 enters the separation unit 24.

In some aspects, the separation unit 24 is a PSA-based gas separation unit that has selective hydrogen or nitrogen adsorption to separate the gas from the mixture. Pure hydrogen stream 50 exits the separation unit 24, while the remaining off-gas includes the mixture 34 of nitrogen and residual hydrogen, which can be recycled back to the ammonia reactor 12.

FIG. 2 shows an ammonia reactor 100 (e.g., a membrane-based, autothermal ammonia reactor) such as the ammonia reactor 12 of FIG. 1. The ammonia reactor 100 includes a chamber 102 (e.g., a high-pressure chamber, vessel, or tank) and a membrane 104 (e.g., a hydrogen-separation membrane). The chamber 102 has a combustion zone 108, a drying zone 110, a decomposition zone 112 (e.g., a catalytic zone), and a hydrogen zone 114. In some aspects, the chamber 102 has an ammonia decomposition catalyst 106 within the decomposition zone 112. The decomposition catalyst 106 helps the ammonia decompose upon contact with the catalyst 106, combined with the heating of the ammonia. The decomposition catalyst 106 can be any type of catalyst used for ammonia cracking. For example, the decomposition catalyst 106 can be a solid material (e.g., pellets, granules, powders, monolithic structures, etc.) and can be, for example, an iron-based catalyst, a nickel-based catalyst, a ruthenium-based catalyst, a cobalt-based catalyst, etc.

The chamber 102 has a first fluid inlet 120, a first fluid outlet 121, a second fluid inlet 123, a second fluid outlet 124, a third fluid inlet 125, and a third fluid outlet 126. The chamber 102 receives, through the first fluid inlet 120, ammonia 128 and a reaction fluid 130 such as air 130 (or oxygen). In some aspects, the ammonia 128 is mixed with residual hydrogen. In some aspects, the inlet 120 receives (from the same pipes or other pipes) other fluids such as a mixture of hydrogen and nitrogen (as shown in FIG. 1), ammonia from an ammonia polisher, etc.

The combustion zone 108 is fluidly coupled with the inlet 120, the drying zone 110 is fluidly coupled with the second fluid inlet 123 and second fluid outlet 124, the decomposition zone 112 is fluidly coupled with the third fluid outlet 126, and the hydrogen zone 114 is fluidly coupled with the first fluid outlet 121 and the third fluid inlet 125.

In some aspects, the membrane 104 has a cylindrical shape and is disposed at the core and bottom of the chamber 102. The membrane 104 has an external and retentate surface 144 that defines, with an internal wall 170 of the chamber, an annulus 172. The membrane 104 prevents all or most of the nitrogen from flowing from the decomposition zone 112 to the hydrogen zone 114 such that nitrogen is kept in the decomposition zone 112 in contact with the retentate side 144. The membrane 104 can include, for example, a thin and flexible material (e.g., palladium, polymer, ceramic, metal, etc.) in the shape of sheets, foils, films, tubes, etc. Then, the membrane 104 acts as a very fine filter that allows hydrogen gas to pass through the filter without allowing the nitrogen gas to pass through. The decomposition zone 112 resides within the annulus 172 and the hydrogen 140 flows inwardly from the annulus 172 to the hydrogen zone 114 within the membrane 104.

The hydrogen zone 114 is at the membrane 104 and is downstream of the decomposition zone 112. The membrane 104 separates the decomposition zone 112 from the hydrogen zone 114 such that the decomposition zone 112 is either surrounded by or surrounding the hydrogen zone 114 (and by extension, the membrane 104). The decomposition zone 112 is in thermal communication with the combustion zone 108 such that the ammonia 128 in the decomposition zone 112 is heated by the heat generated in the combustion zone 108. The hydrogen zone 114 is fluidly coupled with the fluid outlet 121 to allow the permeated hydrogen 140 to exit the chamber 102.

The air 130 and a portion of the ammonia 128 flows from the fluid inlet 120 at the top of the chamber 102 to the combustion zone 108, which is the uppermost zone of the chamber 102. At the combustion zone 108, the air 130 and the portion of the ammonia 128 exothermically react (e.g., forming or causing a combustion) to generate thermal energy. The exothermic reaction of oxygen molecules with ammonia molecules produce nitrogen and water. Another portion of the ammonia 128 (e.g., the unreacted ammonia or ammonia from another pipe) is flowed from the combustion zone 108 (or from another pipe attached to the decomposition zone 112) into the decomposition zone 112 to decompose or disassociate into hydrogen 140 (e.g., hydrogen gas) and nitrogen 142 (e.g., nitrogen gas). The ammonia 128 decomposes as the ammonia 128 is exposed to the thermal energy from the combustion zone 108 and contacts the ammonia decomposition catalyst 106. The hydrogen 140 from the decomposition zone 112 flows, through a surface 144 (e.g., a retentate surface or side 144) of the membrane 104, to the hydrogen zone 114 within the membrane 104. The hydrogen 140 exits the chamber 102 through the third fluid outlet 126.

To extract the permeated hydrogen 140 from the chamber 102, a sweep gas 154 can be flowed into the chamber 102 through the second inlet 123. In some aspects, the sweep gas 154 enters a fluid conduit 119 of the membrane 104 and spreads through the membrane 104 to then exit through the outlet 121. In other words, the second inlet 123 is fluidly coupled with the hydrogen zone 114 so that the hydrogen zone 114 receives, through the second inlet 123, the sweep gas that then exits the chamber 102 through the fluid outlet 121 to sweep the hydrogen out of the chamber 102. The sweep gas 154 can be, for example, steam. Sweeping the hydrogen 140 can help avoid any hydrogen pressure build-up on the permeate side 145 of the membrane 104. Because high partial pressures of hydrogen on the permeate side 145 can lower the permeation flux of the membrane 104 due to a lower difference in the partial pressures between the retentate side 144 and the permeate side 145 of the membrane 104. Thus, hydrogen 140 along with the sweep gas 154 exit the reactor from the permeate side 145 through outlet 121 while a mixture 160 of the unreacted residual ammonia, product nitrogen, and residual hydrogen exit from the retentate side 144 through outlet 126 of the chamber 102. Thus, the membrane 104 allows the in-situ separation of hydrogen 140 after the autothermal ammonia cracking/decomposition process.

The drying zone 110 is disposed between the combustion zone 108 and the decomposition zone. In some aspects, the combustion zone 108 and the drying zone 110 are spaced by a plate 150 such as a filter or a wall with a fluid port. In some aspects, their combustion zone is fluidly decoupled from the decomposition zone, and the decomposition zone receives ammonia from outside the chamber. In some aspects, the combustion zone 108 and the drying zone 110 are not separated by a physical division. In some aspects, the drying zone 110 and the decomposition zone 112 (and the hydrogen zone 114) are spaced by a plate 152 such as a filter or a wall with a fluid port. In some aspects, the drying zone 110 and the decomposition zone 112 are not separated by a physical division.

The exothermic reaction of the ammonia 128 and air 130 produce a fluid 156 or fluids that include nitrogen and water. The water can be removed at the drying zone 110 by a drying agent 158 that absorbs at least some of the water produced in the combustion zone 108. Specifically, the dry zone 110 includes a bed of drying agent 158 to absorb the water molecules produced during the combustion reaction. In some aspects, a mixture 157 that includes the drying agent and water (and nitrogen) exits the chamber 102 through the fluid outlet 124. The drying agent can include, for example, silica gel, activated alumina, magnesium sulfate, calcium oxide, calcium nitride, ammonium nitrate, sodium sulfate, etc. In some aspects, the drying agent 158 can be “regenerated” in-situ through the passage of a gas such as nitrogen. For example, when the drying agent 158 reaches its saturation point, nitrogen can pass through the drying agent to change its pressure and thus remove the adsorbed water.

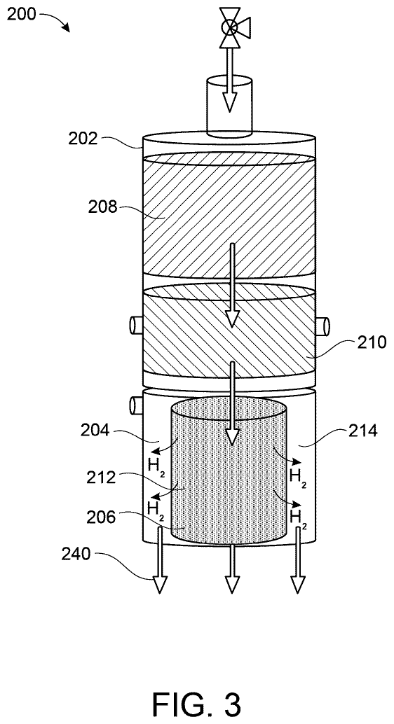

FIG. 3 shows an ammonia reactor 200 similar to the ammonia reactor 100 of FIG. 2, with the main exception that the membrane 204 (and by extension, the hydrogen zone 214) of the ammonia reactor 200 has a ring-like shape surrounding the decomposition zone 212. The chamber 202 has a combustion zone 208, a drying zone 210, a decomposition zone 212, and a hydrogen zone 214. The ammonia decomposition catalyst 206 resides within the decomposition zone 212. In other words, the decomposition catalyst 206 is placed in the reactor core while the permeate side of the membrane 204 is placed in the “annulus” of the reactor 200. The hydrogen exits the chamber 202 from the hydrogen zone 214 at the permeate side of the membrane 204. The mixture of the unreacted residual ammonia, product nitrogen, and residual hydrogen exit the chamber 202 from the retentate side of the membrane 204, which faces the decomposition zone 212. The hydrogen 240 flows out of the chamber 202 through the bottom of the chamber 202, and the residual ammonia and other gases exit the chamber 202 through the bottom of the chamber 202 at the decomposition zone 212.

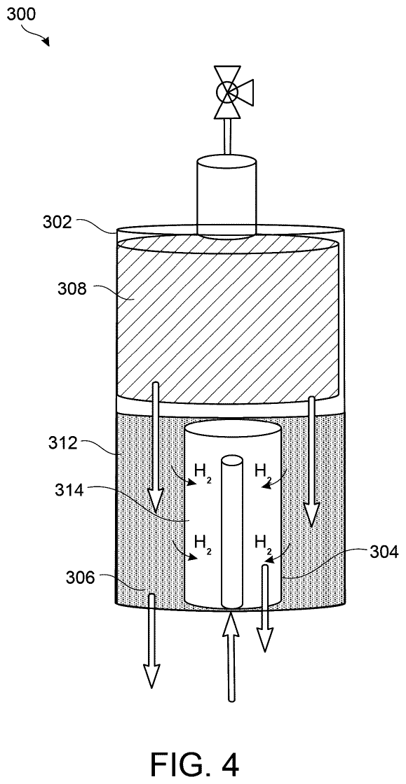

FIG. 4 shows an ammonia reactor 300 similar to the ammonia reactor 100 of FIG. 2, with the main exception that the chamber 302 does not include a drying zone. Thus, the chamber 302 has a combustion zone 308, a decomposition zone 312, and a hydrogen zone 314. In some aspects, because the chamber 302 does not have a drying zone, the catalyst 306 can resist the presence of water molecules to prevent a deterioration of the catalyst 306 in the presence of water molecules. Specifically, the catalyst 306 can be made of a material that is water-resistant or that does not deteriorate (e.g., does not rust or scale). Similar to the ammonia reactor 100 of FIG. 2, the membrane 304 has a cylindrical shape disposed at the core and bottom of the chamber 302.

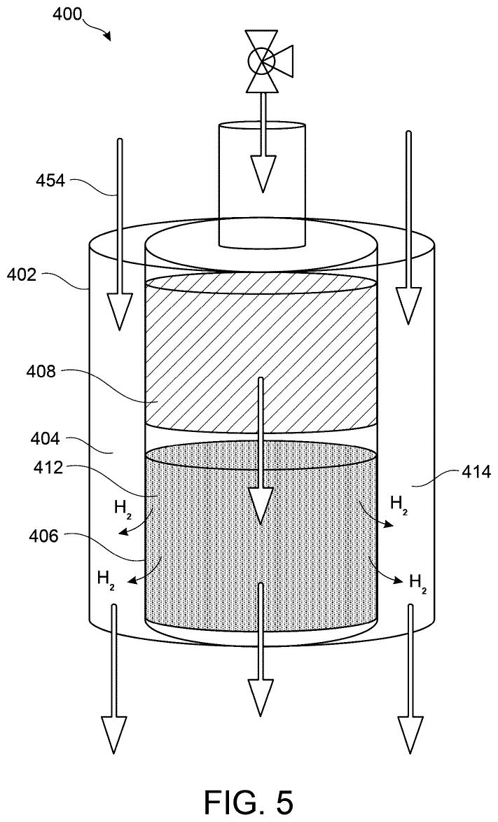

FIG. 5 shows an ammonia reactor 400 with a hydrogen zone 414 at the annulus of the chamber 402. Specifically, the hydrogen zone 414 spans the length of the chamber 302 such that the hydrogen zone 414 surrounds the combustion zone 408 and the decomposition zone 412. The chamber includes a membrane 404 that can span the entire or part of the length of the hydrogen zone 414. The catalyst 406 is disposed adjacent and beneath the combustion zone 408. The chamber 402 can receive a sweep gas 454 through the top of the chamber 402 and can flow the sweep gas 454 with the hydrogen out of the annular volume through the bottom of the chamber 402. The residual ammonia and other gases exit the chamber 402 through the bottom of the chamber 402 at the decomposition zone 412.

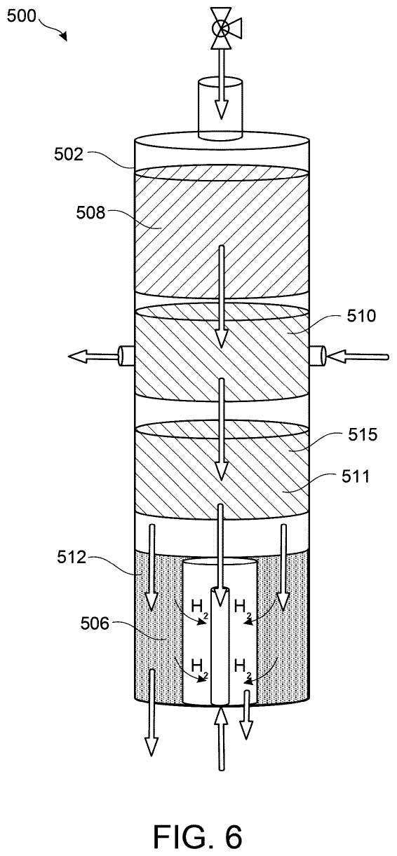

FIG. 6 shows an ammonia reactor 500 with two decomposition zones 511, 512. The second decomposition zone (e.g., low/medium-temperature catalyst zone) is at the bottom of the chamber 502 and the first decomposition zone 511 (e.g., the high temperature catalyst zone) resides between the combustion zone 508 and the second decomposition zone 512. The chamber 502 can also have a drying zone 510, in which case the first decomposition zone 511 is disposed between the drying zone 510 and the second decomposition zone 512. The first decomposition zone 511 includes a high-temperature ammonia decomposition catalyst 515 (e.g., a catalyst bed) and the second decomposition zone 512 includes a low or medium-temperature decomposition catalyst 506. The first decomposition zone 511 is exposed to a temperature from the combustion zone 508 that is higher than a temperature to which the second decomposition zone 512 is exposed.

The use of a high-temperature catalytic zone 511 and a second low/medium-temperature catalytic zone 512 allows the reactor 500 to use higher combustion temperatures in the combustion zone 508 as opposed to a reactor 500 without the two catalytic zones. Higher combustion temperatures can provide higher fuel consumption ratios in the combustion/reaction zone 508. However, because membrane reactor operation can be more favorable in the medium temperature region (e.g., between 500 and 650 degrees Celsius), the reactor 500 also has a medium/low temperature decomposition zone 512.

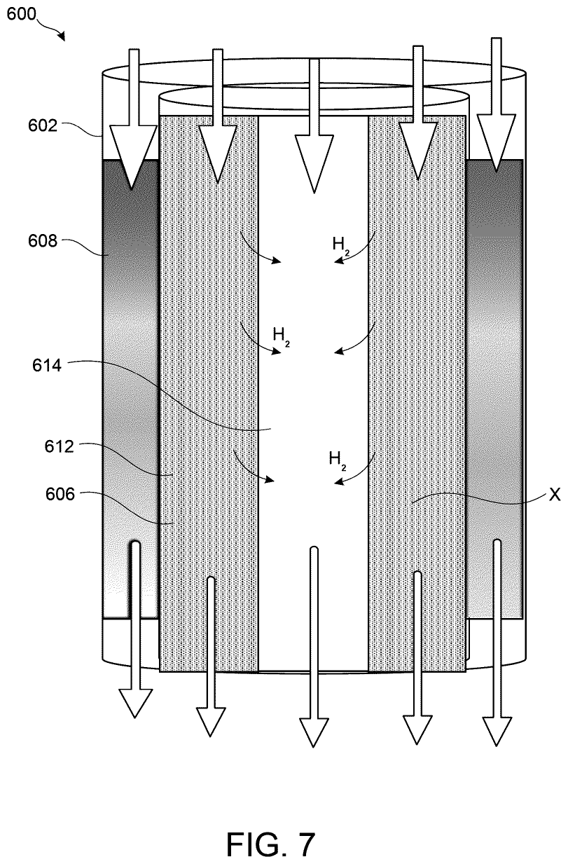

FIG. 7 shows an ammonia reactor 600 with three concentric chambers or volumes. For example, the ammonia reactor 600 has a hydrogen zone 614 at the core of the chamber 602, a decomposition zone 612 surrounding the hydrogen zone 614, and a combustion zone 608 surrounding the decomposition zone 612. All of the zones 608, 612, 614 span the length of the chamber 602 or are substantially the same length. The decomposition zone 612 and combustion zone 608 can be separated by a wall and fluidly decoupled from each other. The combustion zone 608 resides in the outermost region of the reactor 600. Ammonia, air, and residual hydrogen enter the combustion zone 608 through the top of the chamber 602. Combustion takes place in the combustion zone 608 to release thermal energy. This thermal energy is transferred to the decomposition zone 612, which is where the ammonia decomposition catalyst 606 is placed. Ammonia gas is introduced into the decomposition zone 612 where the ammonia decomposes into hydrogen and nitrogen. The produced hydrogen permeates through the membrane that is placed in the hydrogen zone 614. This configuration avoids the contact of combustion gases with the catalyst bed. In other words, the combustion gases in the combustion zone 608 do not contact the gases in the decomposition zone 612.

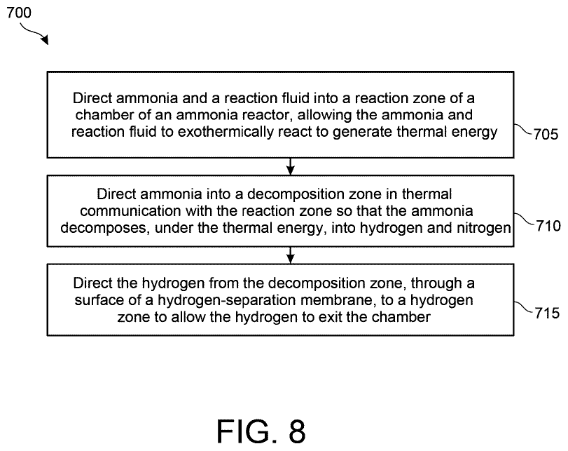

FIG. 8 shows a flow chart 700 of an example method of ammonia cracking. The method includes directing ammonia and a reaction fluid into a combustion zone of a chamber of an ammonia reactor, allowing the ammonia and reaction fluid to exothermically react to generate thermal energy in the combustion zone (705). The method also includes directing ammonia into a decomposition zone of the chamber (710). The decomposition zone in thermal communication with the combustion zone so that the ammonia in the decomposition zone decomposes, under the thermal energy from the combustion zone, into hydrogen and nitrogen. The method also includes directing the hydrogen from the decomposition zone, through a surface of a hydrogen-separation membrane disposed within the chamber, to a hydrogen zone to allow the hydrogen to exit the chamber through the fluid outlet (715).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

### EXAMPLES

In an example implementation, an autothermal ammonia reactor includes a chamber, a hydrogen-separation membrane, and an ammonia decomposition catalyst. The chamber has a fluid inlet and a fluid outlet and is arranged to receive, through the fluid inlet, ammonia and air. The chamber includes a combustion zone fluidly coupled with the inlet. The hydrogen-separation membrane is disposed within the chamber. The chamber includes a catalytic zone and a hydrogen zone at the hydrogen-separation membrane and downstream of the catalytic zone. The hydrogen-separation membrane separates the catalytic zone from the hydrogen zone such that the catalytic zone is either surrounded by or surrounding the hydrogen zone and the hydrogen-separation membrane. The catalytic zone is in thermal communication with the combustion zone and the hydrogen zone is fluidly coupled with the fluid outlet. The ammonia decomposition catalyst is disposed within the catalytic zone. The chamber directs the air and a portion of the ammonia from the fluid inlet to the combustion zone to allow the air and the portion of the ammonia to exothermically react to generate thermal energy. The chamber is arranged to direct another portion of the ammonia into the catalytic zone to decompose into hydrogen and nitrogen as the ammonia is exposed to the thermal energy from the combustion zone and contacts the ammonia decomposition catalyst, and the chamber is arranged to direct the hydrogen from the catalytic zone, through a surface of the hydrogen-separation membrane, to the hydrogen zone to allow the hydrogen to exit the chamber through the fluid outlet.

In an example implementation combinable with any other example implementation, the air and the portion of the ammonia exothermically react to produce nitrogen and water, and the chamber is arranged to direct the produced nitrogen and water out of the chamber. In an example implementation combinable with any other example implementation, the autothermal ammonia reactor further includes a drying zone disposed between the combustion zone and the catalytic zone. The drying zone includes a drying agent configured to absorb at least some of the water produced in the combustion zone. In an example implementation combinable with any other example implementation, the drying agent is regenerated in-situ through a passage of a drying gas.

In an example implementation combinable with any other example implementation, the hydrogen-separation membrane includes a retentate side facing the catalytic zone and a permeate side facing the hydrogen zone. The hydrogen-separation membrane is arranged to prevent the nitrogen from flowing from the catalytic zone to the hydrogen zone such that nitrogen is kept in the catalytic zone in contact with the retentate side. The catalytic zone fluidly coupled to a second fluid outlet through which the nitrogen exits the chamber.

In an example implementation, an ammonia reactor includes a chamber that includes a fluid inlet and a fluid outlet. The chamber receives, through the fluid inlet, ammonia and a reaction fluid. The chamber includes a combustion zone fluidly coupled with the inlet, a decomposition zone in thermal communication with the combustion zone, and a hydrogen zone downstream of the decomposition zone. The hydrogen zone is fluidly coupled with the fluid outlet. The hydrogen-separation membrane resides within the chamber and separates the decomposition zone from the hydrogen zone. The chamber is arranged to direct the reaction fluid and ammonia from the fluid inlet to the combustion zone to allow the reaction fluid and ammonia to exothermically react to generate thermal energy. The chamber is arranged to direct ammonia to the decomposition zone to decompose into hydrogen and nitrogen under the thermal energy from the combustion zone. The chamber is arranged to direct the hydrogen from the decomposition zone, through a surface of the hydrogen-separation membrane, to the hydrogen zone to allow the hydrogen to exit the chamber through the fluid outlet.

In an example implementation combinable with any other example implementation, the hydrogen zone is at the hydrogen-separation membrane. The hydrogen-separation membrane includes a cylindrical shape or a ring-like shape such that the decomposition zone is either surrounded by or surrounding the hydrogen-separation membrane. The decomposition zone receives, from the combustion zone, unreacted ammonia.

In an example implementation combinable with any other example implementation, the hydrogen-separation membrane includes a cylindrical shape at a core of the chamber. The hydrogen-separation membrane includes an external and retentate surface that defines, with an internal wall of the chamber, an annulus, the decomposition zone residing within the annulus, and the hydrogen flows inwardly from the annulus to the hydrogen zone within the hydrogen-separation membrane.

In an example implementation combinable with any other example implementation, the hydrogen zone is at the core of the chamber and spans a length of the chamber. The combustion zone spans the length of the chamber, and the chamber includes a concentric volume fluidly decoupled from and surrounding the combustion zone. The combustion zone resides at the concentric volume.

In an example implementation combinable with any other example implementation, the hydrogen-separation membrane includes a ring-like shape. The hydrogen-separation membrane includes an internal and retentate surface facing an inner volume at the core of the chamber. The decomposition zone residing within the inner volume at the core of the chamber, and the hydrogen flows outwardly from the inner volume to the hydrogen zone within the hydrogen-separation membrane.

In an example implementation combinable with any other example implementation, the hydrogen zone spans a length of the chamber such that the hydrogen zone surrounds the combustion zone.

In an example implementation combinable with any other example implementation, the chamber further includes a second inlet fluidly coupled with the hydrogen zone and receives a sweep gas to sweep the hydrogen out of the chamber.

In an example implementation combinable with any other example implementation, the chamber further includes a second decomposition zone disposed between the combustion zone and the decomposition zone and including a high-temperature ammonia decomposition catalyst bed. The second decomposition zone is exposed to a temperature from the combustion zone that is higher than a temperature to which the decomposition zone is exposed.

In an example implementation combinable with any other example implementation, the reaction fluid includes oxygen that exothermically reacts with the ammonia to produce nitrogen and water, and the chamber further includes a drying zone disposed between the combustion zone and the decomposition zone and including a drying agent configured to absorb at least some of the water produced in the combustion zone.

In an example implementation combinable with any other example implementation, the hydrogen-separation membrane includes a retentate side facing the decomposition zone and a permeate side facing the hydrogen zone. The hydrogen-separation membrane is arranged to prevent the nitrogen from flowing from the decomposition zone to the hydrogen zone such that nitrogen is kept in the decomposition zone in contact with the retentate side. The decomposition zone is fluidly coupled to a second fluid outlet through which the nitrogen exits the chamber.

In an example implementation combinable with any other example implementation, the ammonia reactor further includes an ammonia decomposition catalyst disposed within the decomposition zone. The decomposition zone includes a catalytic zone. The chamber is arranged to direct unreacted ammonia to the catalytic zone to decompose into hydrogen and nitrogen under the thermal energy from the combustion zone and upon contact with the ammonia decomposition catalyst.

In an example implementation combinable with any other example implementation, the reaction fluid includes air or oxygen that exothermically reacts with the ammonia to produce nitrogen and water, and the ammonia decomposition catalyst membrane is water-resistant.

In an example implementation, a method includes directing ammonia and a reaction fluid into a combustion zone of a chamber of an ammonia reactor, allowing the ammonia and reaction fluid to exothermically react to generate thermal energy in the combustion zone. The method also includes directing ammonia into a decomposition zone of the chamber. The decomposition zone is in thermal communication with the combustion zone so that the ammonia in the decomposition zone decomposes, under the thermal energy from the combustion zone, into hydrogen and nitrogen. The method also includes, subsequently or simultaneously, directing the hydrogen from the decomposition zone, through a surface of a hydrogen-separation membrane disposed within the chamber, to a hydrogen zone to allow the hydrogen to exit the chamber through the fluid outlet.

In an example implementation combinable with any other example implementation, the reaction fluid includes at least one of air or hydrogen, and directing the ammonia and the reaction fluid includes directing dry ammonia from a distillation column into the chamber, and directing at least one of (i) air from an air source into the chamber, or (ii) hydrogen from a gas separator into the chamber.

In an example implementation combinable with any other example implementation, the method further includes directing the hydrogen out of the chamber into a gas separator that separates a sweep gas from the hydrogen.

What is claimed is:

1. An autothermal ammonia reactor, comprising:
a chamber comprising a fluid inlet and a fluid outlet, the chamber arranged to receive, through the fluid inlet, ammonia and air, the chamber comprising a combustion zone fluidly coupled with the inlet;
a hydrogen-separation membrane disposed within the chamber, the chamber comprising a catalytic zone and a hydrogen zone at the hydrogen-separation membrane and downstream of the catalytic zone, the hydrogen-separation membrane separating the catalytic zone from the hydrogen zone such that the catalytic zone is either surrounded by or surrounding the hydrogen zone and the hydrogen-separation membrane, the catalytic zone being in thermal communication with the combustion zone and the hydrogen zone being fluidly coupled with the fluid outlet; and
an ammonia decomposition catalyst disposed within the catalytic zone;
wherein the chamber is arranged to direct the air and a portion of the ammonia from the fluid inlet to the combustion zone to allow the air and the portion of the ammonia to exothermically react to generate thermal energy, the chamber arranged to direct another portion of the ammonia into the catalytic zone to decompose into hydrogen and nitrogen as the ammonia is exposed to the thermal energy from the combustion zone and contacts the ammonia decomposition catalyst, and the chamber is arranged to direct the hydrogen from the catalytic zone, through a surface of the hydrogen-separation membrane, to the hydrogen zone to allow the hydrogen to exit the chamber through the fluid outlet.

2. The autothermal ammonia reactor of claim 1, wherein the air and the portion of the ammonia exothermically react to produce nitrogen and water, and the chamber is arranged to direct the produced nitrogen and water out of the chamber.

3. The autothermal ammonia reactor of claim 2, further comprising a drying zone disposed between the combustion zone and the catalytic zone, the drying zone comprising a drying agent configured to absorb at least some of the water produced in the combustion zone.

4. The autothermal ammonia reactor of claim 3, wherein the drying agent is regenerated in-situ through a passage of a drying gas.

5. The autothermal ammonia reactor of claim 1, wherein the hydrogen-separation membrane comprises a retentate side facing the catalytic zone and a permeate side facing the hydrogen zone, the hydrogen-separation membrane arranged to prevent the nitrogen from flowing from the catalytic zone to the hydrogen zone such that nitrogen is kept in the catalytic zone in contact with the retentate side, the catalytic zone fluidly coupled to a second fluid outlet through which the nitrogen exits the chamber.

6. An ammonia reactor, comprising:
a chamber comprising a fluid inlet and a fluid outlet, the chamber arranged to receive, through the fluid inlet, ammonia and a reaction fluid, the chamber comprising a combustion zone fluidly coupled with the inlet, a decomposition zone in thermal communication with the combustion zone, and a hydrogen zone downstream of the decomposition zone, the hydrogen zone fluidly coupled with the fluid outlet; and
a hydrogen-separation membrane disposed within the chamber and separating the decomposition zone from the hydrogen zone;
wherein the chamber is arranged to direct the reaction fluid and ammonia from the fluid inlet to the combustion zone to allow the reaction fluid and ammonia to exothermically react to generate thermal energy, the chamber arranged to direct ammonia to the decomposition zone to decompose into hydrogen and nitrogen under the thermal energy from the combustion zone, and the chamber is arranged to direct the hydrogen from the decomposition zone, through a surface of the hydrogen-separation membrane, to the hydrogen zone to allow the hydrogen to exit the chamber through the fluid outlet.

7. The ammonia reactor of claim 6, wherein the hydrogen zone is at the hydrogen-separation membrane, the hydrogen-separation membrane comprising a cylindrical shape or a ring-like shape such that the decomposition zone is either surrounded by or surrounding the hydrogen-separation membrane, and the decomposition zone receives, from the combustion zone, unreacted ammonia.

8. The ammonia reactor of claim 7, wherein the hydrogen-separation membrane comprises a cylindrical shape at a core of the chamber, the hydrogen-separation membrane comprising an external and retentate surface that defines, with an internal wall of the chamber, an annulus, the decomposition zone residing within the annulus, and the hydrogen flows inwardly from the annulus to the hydrogen zone within the hydrogen-separation membrane.

9. The ammonia reactor of claim 8, wherein the hydrogen zone is at the core of the chamber and spans a length of the chamber, the combustion zone spans the length of the chamber, and the chamber comprises a concentric volume fluidly decoupled from and surrounding the combustion zone, the combustion zone residing at the concentric volume.

10. The ammonia reactor of claim 7, wherein the hydrogen-separation membrane comprises a ring-like shape, the hydrogen-separation membrane comprising an internal and retentate surface facing an inner volume at a core of the chamber, the decomposition zone residing within the inner volume at the core of the chamber, and the hydrogen flows outwardly from the inner volume to the hydrogen zone within the hydrogen-separation membrane.

11. The ammonia reactor of claim 10, wherein the hydrogen zone spans a length of the chamber such that the hydrogen zone surrounds the combustion zone.

12. The ammonia reactor of claim 6, wherein the chamber further comprises a second inlet fluidly coupled with the hydrogen zone and configured to receive a sweep gas to sweep the hydrogen out of the chamber.

13. The ammonia reactor of claim 6, wherein the chamber further comprises a second decomposition zone disposed between the combustion zone and the decomposition zone and comprising a high-temperature ammonia decomposition catalyst bed, the second decomposition zone exposed to a temperature from the combustion zone that is higher than a temperature to which the decomposition zone is exposed.

14. The ammonia reactor of claim 6, wherein the reaction fluid comprises oxygen that exothermically reacts with the ammonia to produce nitrogen and water, and the chamber further comprises a drying zone disposed between the combustion zone and the decomposition zone and comprising a drying agent configured to absorb at least some of the water produced in the combustion zone.

15. The ammonia reactor of claim 6, wherein the hydrogen-separation membrane comprises a retentate side facing the decomposition zone and a permeate side facing the hydrogen zone, the hydrogen-separation membrane arranged to prevent the nitrogen from flowing from the decomposition zone to the hydrogen zone such that nitrogen is kept in the decomposition zone in contact with the retentate side, the decomposition zone fluidly coupled to a second fluid outlet through which the nitrogen exits the chamber.

16. The ammonia reactor of claim 6, further comprising an ammonia decomposition catalyst disposed within the decomposition zone, the decomposition zone comprising a catalytic zone, the chamber arranged to direct unreacted ammonia to the catalytic zone to decompose into hydrogen and nitrogen under the thermal energy from the combustion zone and upon contact with the ammonia decomposition catalyst.

17. The ammonia reactor of claim 16, wherein the reaction fluid comprises oxygen that exothermically reacts with the ammonia to produce nitrogen and water, and the hydrogen-separation membrane is water-resistant.

18. A method, comprising:
directing ammonia and a reaction fluid into a combustion zone of a chamber of an ammonia reactor, allowing the ammonia and reaction fluid to exothermically react to generate thermal energy in the combustion zone;
directing ammonia into a decomposition zone of the chamber, the decomposition zone in thermal communication with the combustion zone so that the ammonia in the decomposition zone decomposes, under the thermal energy from the combustion zone, into hydrogen and nitrogen; and
directing the hydrogen from the decomposition zone, through a surface of a hydrogen-separation membrane disposed within the chamber, to a hydrogen zone to allow the hydrogen to exit the chamber.

19. The method of claim 18, wherein the reaction fluid comprises at least one of air or hydrogen, and directing the ammonia and the reaction fluid comprises directing dry ammonia from a distillation column into the chamber, and directing at least one of (i) air from an air source into the chamber, or (ii) hydrogen from a gas separator into the chamber.

20. The method of claim 18, further comprising directing the hydrogen out of the chamber into a gas separator that separates a sweep gas from the hydrogen.
